(19) United States
(12) Patent Application Publication
(10) Pub. No.: US 2017/0367514 A1
(43) Pub. Date: Dec. 28, 2017

(54) SMOKELESS AIR BLADE WOK

(71) Applicant: KONINKLIJKE PHILIPS N.V., EINDHOVEN (NL)

(72) Inventors: ROBERTUS LEONARDUS MARIA IN 'T GROEN, EINDHOVEN (NL); MICHIEL DE JONG, EINDHOVEN (NL); EDUARD MATHEUS JOHANNES NIESSEN, EINDHOVEN (NL); SUZANNE DANIËLLE VAN DER ZAAN-LANDWEHR JOHAN, EINDHOVEN (NL)

(21) Appl. No.: 15/544,040

(22) PCT Filed: Jan. 7, 2016
(86) PCT No.: PCT/EP2016/050213

§ 371 Date: Jul. 17, 2017

(30) Foreign Application Priority Data
Jan. 19, 2015 (EP) 15151590.5

(51) Int. Cl. A47J 27/00; A23L 5/10; A47J 36/00

(52) U.S. Cl. CPC A47J 27/002; A47J 36/00; A23L 5/10; A23V 2002/00

(57) ABSTRACT

The invention provides a food preparation vessel (100) comprising a main inlet (10) for introduction of a food material into the food preparation vessel (100), wherein the food preparation vessel (100) comprises a gas flow generator outlet (21) and a gas flow receiver inlet (22), wherein the gas flow generator outlet (21) is configured to provide a gas flow (25) in the direction of the gas flow receiver inlet (22) and having a component parallel to the main inlet (10) when the gas flow generator outlet (21) is functionally coupled with a gas flow generator in operation.

### FIELD OF THE INVENTION

The invention relates to a food preparation vessel. The invention further relates to a combination of a food preparation vessel and a base station. Further, the invention also relates to a method for preparing food with such food preparation vessel, optionally in combination with such base station.

### BACKGROUND OF THE INVENTION

Electrical means to aid cooking are known in the art. EP1912024, for instance, describes a food preparation apparatus comprising a top cooking surface, or cooktop, a front wall, a clear see-through wall located on the front side and extending above said top surface, suction means adapted to take in fumes/odors or gases being generated at and released from said cooktop, said suction means comprising a forward inclined intake grille arranged between said cooktop and said vertical wall; the clear see-through wall is curved backwards, with the lower portion thereof extending almost vertically and then gradually curving backwards. A chamber collecting the gases being taken in is arranged below said grille and debouches into a vertical suction conduit, to which there is associated an appropriate suction fan, entering a prismatic filtering chamber provided with a filter in the form of a filtering partition arranged between two opposite sides of said chamber and lying orthogonally to the rear wall of the apparatus.

### SUMMARY OF THE INVENTION

When stir frying at home, smoke and splashes are an issue for many consumers. To exemplify this issue, many consumers fix paper or aluminum foil behind their stoves to prevent permanent damage to the walls from smoke, oil fumes and splashes. Consumers also get more and more worried about the health aspects of smoke and fumes.

Presently, appliances are available that automatically fry in an enclosed environment, such that smoke, fumes and splashes can be contained inside the device. However, it was unfortunately observed that this kind of frying in an enclosed environment does not yield acceptable food results. For a number of cooking methods, high temperature is required for a good result, e.g. for stir frying a temperature of 200° C. and above is needed. If the cooking chamber is closed with for example a lid, the cooking method will effectively change into steaming with a maximum temperature of 100° C., and thus stir fry results are disabled.

It surprisingly appeared that there are at least two key boundary conditions which should be fulfilled to provide an improvement in cooking: an alternative method should be similar to an already existing method; and an alternative method may have all kind of advantages but should not sacrifice on taste of the cooked dishes.

In the professional market, kitchen ventilator companies have introduced heavy duty solutions with integrated powerful air filtration. However, this type of product is not suitable for home use by consumers. First of all, there may be doubts on whether it can prevent enough smoke and splash. Additionally, the size and installation may not easily be suitable for a standard consumer kitchen.

Hence, it is an aspect of the invention to provide an alternative food preparation vessel, which preferably further at least partly obviates one or more of the above-described drawbacks. Hence, it is also an aspect of the invention to provide an alternative food preparation vessel system, which preferably further at least partly obviates one or more of the above-described drawbacks. Yet, it is also an aspect of the invention to provide an alternative food preparation method, which preferably further at least partly obviates one or more of the above-described drawbacks.

To increase the effectiveness in containing smoke and splashes of cooking, as well as to enable smaller device solutions, the present invention proposes to introduce an air blade/air knife just over the top of the pan or other type of cooking vessel. This provides a closing for undesired side effect such as smoke and splashes, while still allowing access by the user, as well as visual inspection. The presently proposed solution provides important consumer benefits in terms of convenience, safety and high performance cooking. In the proposed solution smoke and smell may be kept inside the vessel, such as a wok, and the splashes may also be kept inside the vessel. Nevertheless, visual inspection of the food stuff in the vessel is substantially not disturbed, and also the use of cooking utensils is not obstructed. Further, high temperature cooking is (still) enabled and food quality and the cooking process are not (substantially) affected. Hence, the present invention may provide the same quality of food and the same food experience as with conventional cooking and with conventional cooking appliances, whereas the cooking process may be improved, and may be more convenient for the person that prepares the food.

Therefore, in a first aspect the invention provides a food preparation vessel (herein also indicated as “vessel”) comprising a main inlet for introduction of a food material into the food preparation vessel, wherein the food preparation vessel comprises a gas flow generator outlet and a gas flow receiver inlet, wherein the gas flow generator outlet is configured to provide a gas flow (i.e. especially air flow) in the direction of the gas flow receiver inlet and having a component parallel to the main inlet when the gas flow generator outlet is functionally coupled with a gas flow generator in operation. Hence, the gas flow has a gas flow component (substantially) parallel to the main inlet.

In yet a further aspect, the invention also provides a combination (“kit of parts”; herein also called “food preparation vessel system”) of a base station and the food preparation vessel, such as especially further defined herein, wherein one or more of the base station and the food preparation vessel comprise said gas flow generator. Especially, a combination is provided comprising a base station and a food preparation vessel, wherein the food preparation vessel comprises a main inlet for introduction of a food material into the food preparation vessel, and wherein the combination comprises a gas flow generator, especially wherein the base station comprises said gas flow generator, and wherein the combination further comprises a gas flow generator outlet and a gas flow receiver inlet, wherein the gas flow generator outlet is configured to provide a gas flow in the direction of the gas flow receiver inlet and having a component parallel to the main inlet when the gas flow generator outlet is functionally coupled with the gas flow generator in operation. In a specific embodiment, the food preparation vessel of the combination is especially the above defined food preparation vessel comprising said gas flow generator outlet and said gas flow receiver inlet (see further also below).

With such vessel or combination (of vessel and base station), it is possible to prepare food and/or to cook food material in a conventional way, but substantially reduce the escape from food material, water, oil, etc. With the gas flow, especially the air knife based gas flow, it is now possible to capture e.g. smell and/or splashes coming from the food material inside the vessel, while the food material in the vessel can still be viewed via the main inlet (through the gas flow) during preparation. The term “air knife based gas flow” especially indicates that the gas flow is provided as air knife (or air blade).

Undesired escape of material such as food material, water, oil, etc., can also be prevented in a closed vessel, but then the food preparation process may be affected (see also above) and also visual acces may be more difficult, while physical access is not possible.

Hence, the present food vessel combines a number of features that allow the user executing substantially the same food preparation process as known to the user, but with less (or substantially no) concomittant disadvantages. Hence, the gas flow, especially the air knife based gas flow, is used as a kind of cover closing the main inlet (closing the vessel interior), while still allowing at least visual inspection of the food material in the vessel. Note that in a specific embodiment, in addition to the gas flow cover, a physical cover may be applied. For instance, the gas flow may be reduced, including optionally switched off, when the cover is arranged on or in the main inlet, but may at least temporarily be increased, including switched on, when the cover is removed. Hence, the invention does not exclude (in embodiments) the use of a physical cover to at least partially close the main inlet of the food preparation vessel. The use of an additional cover may depend upon the type of food preparation process, the type of food preparered, and may optionally also depend upon the user.

The vessel can in principle be any vessel that can be used for preparing a food product. Especially, the vessel is configured to allow heating of food material within the vessel. Further, in an embodiment the vessel is configured to be heatable by open fire, such as a gas cooking. Hence, the vessel may be configured for gas cooking. In yet another embodiment, the vessel may be configured for electrical cooking, such as with a hot plate, like a ceramic (hot) plate. In yet a further embodiment, the vessel may be configured for conduction cooking, with at least part of the vessel configured as heating unit, heatable by electrical conduction. Hence, especially the vessel is steel-based, though other embodiments may also be possible. Especially, the vessel is configured for a food preparation process at elevated temperatures, such as at least 50° C., like at least 90° C., such as even over 150° C., such as may be the case in wok cooking (i.e. cooking with a wok). Hence, in an embodiment the food preparation vessel is further configured to receive heat from a heating unit (for instance comprised by a base station; see further also below) for heating (the food material) at a temperature selected from the range of at least 50° C., such as especially at a temperature selected from the range of at least 90° C., such as at least 100° C., even more especialy at a temperature selected from the range of at least 150° C. In embodiments, the food preparation vessel may include the heating unit, whereas in other embodiments, the heating unit may be included in a base station, and in yet other embodiments, a heating elment may be used that is neither part of the food preparation vessel nor part of the base station. Hence, in embodiments the user may use a food preparation vessel, a base station, especially comprising said gas flow generator, and a (separate) heating unit. Hence, in embodiments, the heating unit may or may not be part of the base station. The term “heating unit” may also refer to a plurality of heating units.

However, the invention may also be applied for other applications. The air knife based gas flow could also prevent or at least reduce splashing in a mixing or stirring device. For instance, the food preparation vessel may also be comprised by a food blender, e.g. without a solid lid in which you can also add components continuously a food component.

The vessel may in principle have any shape. For instance, the main inlet may be round, but optionally the main inlet may also be square, rectangular, or have another shape. The vessel may be configured to have in operation the main inlet configured substantially horizontal. In such embodiment, the gas flow may thus also have a substantially horizontal component. However, in yet another embodiment the vessel may be configured to have in operation the main inlet configured under an angle with a horizontal, such as an angle in the range of larger than 0° and equal to or smaller than 90°, especially equal to or smaller than 80°, such as in the range of 15-80°. Further, the main inlet may especially be configured in a single plane. However, the main inlet may also be non-flat. In view of the efficiency of the gas flow, the main inlet may especially have symmetry, such as least having a plane of symmetry or a circular symmetry. Hence, in an embodiment the main inlet has a square or rectangular cross-section. In yet another embodiment, the main inlet has a circular cross-section. Dependent upon the location of the gas flow generator outlet, square/rectangular or circular may be preferred (see also below). The term “main inlet” especially refers to the inlet through wich food material may be provided into the vessel, and through which visual inspection in the vessel is possible. The main inlet will in general also be the opening through which the (prepared) food product may be retrieved from the vessel. Hence, the term “main inlet” may in principle also refer to “main outlet”. The term “main inlet” may optionally also refer to a plurality of main inlets. However, in general the vessel will have a single main inlet. In a specific embodiment, the food preparation vessel comprises a vessel selected from the group consisting of a frying pan, a steel pan, a braising pan, a roasting pan, a spider, a casserole pan, a Dutch oven, a griddle, a stockpot, a sauté pan, a sauce pan, and a wok. However, other types of pans, etc., may also be possible.

The present invention especially provides a method for preparing food from food material, especially with the herein described food preparation vessel and/or combination of food vessel and base station. Hence, in yet a further aspect the invention also provides a method for preparing food, comprising heating food material into the food preparation vessel as defined herein during a food preparation time, while closing the main inlet with an air knife based gas flow during at least part of the preparation time. This method may include using such food preparation vessel functionally coupled to the (optional) base station. In this way, the food preparation vessel is fluidly closed with the gas flow. Hence, the gas flow is especially provided in such a way that during operation the entire main inlet is closed with the (air knife based) gas flow, except for e.g. a situation wherein an object is introduced in the food preparation vessel (see further also below).

As indicated above, the air knife based gas flow may temporarily be substantially reduced in air flow (speed), or even switched off, for instance to execute actions like providing food material to the vessel, stirring or whipping, removing food material from the vessel, removing food (i.e. especially cooked food material) from the vessel, etc.

Hence, in a specific embodiment the food preparation vessel may further comprise a sensor configured to sense an object external from the food preparation vessel approaching the main inlet or being positioned within the main inlet, wherein a control unit when functionally coupled to said sensor and said gas flow generator is configured to reduce the gas flow as function of a sensor signal of said sensor. Alternatively or additionally, in a specific embodiment the optional base station may further comprise a sensor configured to sense an object external from the food preparation vessel approaching the main inlet or being positioned within the main inlet, wherein a control unit when functionally coupled to said sensor and said gas flow generator is configured to reduce the gas flow as function of a sensor signal of said sensor. Alternatively or additionally, the food preparation vessel, or, when the combination is applied, the food preparation vessel and/or the base station may include a user interface or a mechanical or electronic switch that can be used to induce a gas flow reduction. Further, the gas flow reduction may be a reduction of the gas flow over the entire main inlet, or only over part of the main inlet.

Herein, the term “object” may e.g. refer to one or more of a spoon, a spatula, a whisk, a ladle, a spaghetti server, a potato masher, a skimmer, tongs, etc. However, the term “object” may also refer to a hand or another part of the body, such as a face. The sensor may be configured to sense an “object external from the food preparation vessel approaching the main inlet or being positioned within the main inlet”. Here, the term “object” may also refer to a plurality of objects. Also the term “sensor” may refer to a plurality of sensors. Further, the term “or” in “object external from the food preparation vessel approaching the main inlet or being positioned within the main inlet” does not exclude that the sensor is configured to sense both an object external from the food preparation vessel approaching the main inlet and an(other) object external from the food preparation vessel being positioned within the main inlet, even optionally at the same time. In an embodiment, the control unit may at least partially be integrated in the food preparation vessel. In yet another embodiment, the control unit may at least partially be integrated in the optional base station (see also below).

The phrase “configured to reduce the gas flow” may indicated that the gas flow is reduced to a gas flow speed lower than necessary for an air knife. For instance, the gas flow speed may be reduced to less than 5 m/s, such as equal to or less than 1 m/s. In a specific embodiment, the gas flow may (substantially) be switched off. Hence, the invention also provides the method as described above, wherein air knife based gas flow is reduced when an object external from the food preparation vessel approaches the main inlet or is positioned within the main inlet. Hence, during cooking the gas flow speed may be high, to provide the air knife. However, when one desires to introduce a food component, or one desires to stir, the gas flow speed may substantially be reduced. Thereby, the user may e.g. easily introduce a food component or easily stir, respectively. As indicated above, also a part of the gas flow may be reduced or blocked, leaving a part of the food preparation vessel, more precisely part of the main inlet, being closed by the gas flow, and part of the food preparation vessel, more precisely part of the main inlet, being provided with a gas flow with a much lower speed, or even switched off. Hence, the phrase “configured to reduce the gas flow” may also include “configured to locally reduce the gas flow”.

In an embodiment, the gas flow may also be heated before escaping from the gas flow generator outlet. Hence, the air knife based gas flow may be a hot gas flow, such as having a temperature of at least 50° C., such as at least about 90° C., such as especially at least about 100° C. The heating of the gas may be a passive heating, such as by guiding the gas flow in a gas flow infrastructure (see also below) through a part of the wall of the vessel, by which the gas flow may be heated in embodiments wherein the food preparation vessel is heated anyhow. However, alternatively or additionally the food preparation vessel and/or the optional base station may include a gas flow heating element. Such gas flow heating element is especially configured to heat the gas flow before emanating from the gas flow generator outlet.

The term “food material” may also refer to a plurality of food materials. Hence, the method herein described may also relate to a method for preparing a food product from a plurality of food materials, especially in a cooking process. In general, more than one food material may be present, as even water, or another aqueous liquid, as e.g. boiling liquid, or oil or fat as baking liquid, or oil as frying liquid, may (in embodiments) be considered a food material. However, the term food material herein especially relates to at least a food material selected from the group consisting of meat, a vegetable, a fruit and a cereal. Further, the term “food material” may include an ingredient, such as one or more of an herb and a spice. Further, the term “food material” may refer to a sauce and a syrup. Yet further embodiment, the term “food material” may refer to one or more of potatoes and rice. Yet in a further embodiment, the term “food material” may refer to e.g. tofu, beans, eggs, mushroom, a (solid) dairy product, etc. In yet another embodiment, the term “food material” may also relate to a dairy product, including milk.

Here, the term “meat” may refer to the biological term, i.e. one or more of meat, fish, mollusks, etc. The term “vegetable” especially refers to the biological term, i.e. one or more of broccoli, cauliflower, globe artichokes, kale, collard greens, spinach, arugula, beet greens, bok choy, chard, choi sum, turnip greens, endive, lettuce, mustard greens, watercress, garlic chives, gai lan, leeks, Brussels sprouts, Kohlrabi, galangal, and ginger, celery, rhubarb, cardoon, Chinese celery, asparagus, bamboo shoots, potatoes, Jerusalem artichokes, sweet potatoes, taro, and yams, soybean, mung beans, urad, and alfalfa, carrots, parsnips, beets, radishes, rutabagas, turnips, and burdocks, onions, shallots, garlic, but also tomatoes, cucumbers, squash, zucchinis, pumpkins, peppers, eggplant, tomatillos, chayote, okra, breadfruit, avocado, pods, and optionally also seeds such as corn, green beans and snow peas, etc. The term “fruit” may also especially refer to the biological term, i.e. one or more of apple, apricot, banana, breadfruit, blackberry, blackcurrant, blueberry, currant, cherry, date, dragon fruit, fig, gooseberry, grape, grapefruit, guava, kiwi fruit, kumquat, legume, lemon, lime, lychee, mango, melon (e.g. including watermelon), honeydew, nectarine, orange, mandarine, tangerine, papaya, passion fruit, peach, plum, pineapple, pomegranate, pomelo, raspberry, rambutan, star fruit, strawberry, etc. Herein, the term “cereal” especially refers to one or more of maize (corn), rice, wheat, buckwheat, barley, sorghum, millet, oats, rye, etc. Herein the term “dairy” especially refers to one or more of cream, butter, cheese, yoghurt, quark (sometimes also indicated as curd cheese), milk, crème fraiche, etc.

The food preparation method (or process) may especially include a cooking process. The term “cooking process”, or simply “cooking”, may refer e.g. to roasting, baking, boiling, frying, steaming or smoking, especially baking, boiling, or frying. Herein, the term “cooking process” especially refers to a process wherein one or more of meat, a vegetable, a fruit and a cereal is cooked (as first food material(s)), especially in combination with one or more of an aqueous liquid, oil, fat, etc. The term “aqueous liquid” may refer to one or more of water, wine, beer, milk (including one or more of cow milk, sheep milk, goat milk, horse milk, soy milk, etc.), etc. The cooking process may include a boiling liquid, a frying liquid, (baking) fat, etc. However, the cooking process may also include a process substantially without such liquid. The term “cooking” or “cooking process” especially relates to a method wherein the food material is subject to a temperature above 50° C., such as at least about 90° C., such as especially at least about 100° C. The term “cooking” may especially refer to the practice of preparing a food product for consumption from food material with the use of heat. The term “cooking” may for instance refer to roasting, baking, boiling, frying, smoking, etc. Specific examples are e.g. grilling, broiling, flash baking, blanching, poaching, steaming, deep frying, stir frying, wok cooking, etc. Hence, the term “cooking” or the phrase “method for preparing food” may relate to a heating process wherein the food material may change one or more properties, such as by baking or frying, etc., but may also relate to a heating process wherein the food material is substantially only heated (not taking account of actions like stirring, as will be clear to a person skilled in the art). As indicated above, the phrase “method for preparing food” may include a method wherein the food material is heated but may in embodiments also refer to other food preparation processes.

Hence, with the food preparation vessel and the food preparation method especially a food product may be prepared from food material. As indicated above, this may include a process wherein such food product is made from a plurality of food materials. The term “food product” may amongst others refer to a “single” food product such as a (cooked) cauliflower, cooked meat, cooked potatoes, fried potatoes, baked fish, etc.

Returning to the vessel, as indicated above the vessel comprises a gas flow generation outlet. This implies that from the outlet, during operation and during at least part of the operation time, a gas flow emanates. Especially, this is the herein indicate air knife. The air knife technology is known in the art, and is e.g. used in hand driers. The air knife technology is amongst others described in US 2013/0269208 and U.S. Pat. No. 6,742,285, which are herein incorporated by reference. The gas flow as described in the present application is especially a substantially uniform sheet of sheet like air flow, which is sometimes also indicated as streamline flow, or as laminar flow. The sheet like air flow may also be indicated as blade like (gas flow) or knife like (gas flow).

The term “gas flow generator outlet” does not necessarily imply that the gas flow generator is integrated in the food preparation vessel (see also below). However, this term may especially indicate that the gas flow generator outlet may be functionally coupled to such gas flow generator, and—functionally coupled with such gas flow generator in operation—provides said gas flow from said gas flow generator outlet. Especially, the term “gas flow generator outlet” may refer to a plurality of (identical) gas flow generator outlets. As the gas flow generator outlet may especially be configured to generate a sheet like air flow, especially the gas flow generator outlet comprises one or more of (i) a plurality of such outlets substantially configured in a plane, and (b) one or more of such gas flow generator outlets having an aspect ratio larger than 1. In both embodiments, which may thus be combined, it may be possible to generate a sheet like air flow. In a specific embodiment, the gas flow generator outlet has a length (L) and a height (H), wherein L>H, especially wherein L>2H. Further, especially 0.1 mm≦H≦2 mm, like more especially 0.1 mm≦H≦1 mm, such as even more especially 0.1 mm≦H≦0.5 mm. Note that the gas flow receiver inlet may have substantially the same dimensions, but will in generally have one or more larger dimensions (than of the gas flow generator outlet), such as a height which is up to two, or even up to six, yet even up to ten times larger than the height of the gas flow generator outlet. The specific dimensions may depend upon the configuration, including e.g. distance between the gas flow generator outlet(s) and gas flow receiver inlet(s).

The gas flow provided is especially directioned at the gas flow receiver inlet. Hence, the gas flow generator outlet and the gas flow receiver inlet are especially configured such that a part, even more especially a substantial part of the gas flow emanating from the gas flow generator outlet reaches the gas flow receiver inlet. As further discussed below, the gas flow generator outlet and the gas flow recevier inlet may be configured in recycling loop with the gas flow generator providing at least part of the gas flow that emanates from the gas flow generator outlet from the intake of the gas at the gas flow receiver inlet. The term “gas flow receiver inlet” may also refer to a plurality of gas flow receiver inlets. Further, the gas flow generator outlet and the gas flow receiver inlet are especially configured to keep at least 50%, such as at least 75%, like at least 85%, like at least 90% of the internal volume available for the preparation of food, and thus especially substantially free from the direct gas flow.

As indicated above, the gas flow has a component parallel to the main inlet. In this way, the main inlet may be “closed” by the gas flow. The phrase “a component parallel to the main inlet” especially indicates that the gas flow or gas flow velocity or gas flow speed has a component parallel to the main inlet. Would it be able to split the gas flow velocity or gas flow speed in two perpendicular arranged components, at least one of these components will be parallel to the main inlet. Especially, the component parallel to the main inlet is larger, especially substantially larger, than an orthogonal component. For instance, the component parallel to the main inlet may be twice as large or larger, such as at least 5 times as large, than an orthogonal component. Especially, the gas flow has a gas flow speed of at least 5 m/s, even more especially at least 10 m/s. Hence, especially the component parallel to the main inlet has at least said gas flow speed of at least 5 m/s, especially at least 10 m/s, especially in the range of 5-200 m/s, such as 20-200 m/s, like at least 50 m/s. Especailly, the gas flow speed is evaluated at the gas flow generator outlet. The gas flow speed of the gas flow close to the gas flow receiver inlet may be lower. Hence, especially the gas flow generator outlet (in combination with the gas flow generator) is configured to provide said gas flow in the direction of the gas flow receiver inlet and having a component parallel to the main inlet when the gas flow generator outlet is functionally coupled with a gas flow generator in operation, even more especially with a gas flow speed of at least 10 m/s. Yet more especially, the gas flow speed is at least 20 m/s, such as at least 50 m/s, like even at least 100 m/s. The gas flow speed may e.g. be in the range of 5-200 m/s, such as 20-200 m/s, like at least 50 m/s. The phrase “component parallel to the main inlet” especially indicates a component substantially parallel to the main inlet. For instance, there may be a small deviation in the rang of 0-10°, such as especially 0-5°, like 0-2.5° from parallel.

To obtain the above-indicated component parallel to the main opening and in order to have an efficient use of the vessel, especially one or more of the gas flow generator outlet and the gas flow receiver inlet may be comprised in an edge of the vessel. Alternatively or additionally, one or more of the gas flow generator outlet and the gas flow receiver inlet may be comprised in an edge of the (optional) base station (see further also below). However, other configurations, including combinations of these afore-mentioned embodiments, may also be possible (see also below). For instance, the gas flow may emanate from a central part in the main inlet of the food preparation vessel.

In a specific embodiment, the main inlet comprises a food preparation vessel inlet edge, and the food preparation vessel inlet edge comprises said gas flow generator outlet and said gas flow receiver inlet. Such embodiment may especially be relevant when the main inlet has a square or rectangular cross-section. In such embodiment, one edge may include the gas flow generator outlet and an opposite edge (at the other side of the main inlet) may include the gas flow receiver inlet. The other two edges may optionally also include gas flow receiver inlets.

In another embodiment, the food preparation vessel further comprises a hub, wherein the hub comprises said gas flow generator outlet, wherein the main inlet comprises a food preparation vessel inlet edge, wherein the vessel inlet edge comprises said gas flow receiver inlet, wherein the gas flow generator outlet is especially configured to provide a radial gas flow in the direction of said gas flow receiver inlet and having a component parallel to the main inlet when functionally coupled with said gas flow generator in operation. Such embodiment may especially be relevant when the main inlet has a circular cross-section. However, this embodiment may also be used in combination with a square or rectangular cross-section of the main inlet. Hence, in such embodiment the gas flow emanates from a central part in the main inlet of the food preparation vessel. Further, in this embodiment the gas flow receiver inlet may especially be comprised by the food preparation vessel inlet edge.

Especially, part of a gas flow infrastructure is comprised by the vessel. In an embodiment, the entire gas flow infrastructure, including the gas flow generator may be comprised by the vessel. Hence, in an embodiment the gas flow generator may at least partially be integrated in the food preparation vessel. In yet another embodiment, the gas flow generator is fully integrated in the food preparation vessel.

In yet another embodiment, the entire gas flow infrastructure, including the gas flow generator is comprised by the base station. In yet other embodiments, at least part of the gas flow infrastructure is comprised by the vessel, and optionally part of the gas flow infrastructure is comprised by the optional base station. In the above described embodiments, at least the gas flow generator outlet and the gas flow receiver inlet are comprised by the vessel. When the vessel is functionally coupled to a gas flow generator, the gas flow may be generated, escaping from the gas flow generator outlet. The gas is at least partly received by the gas flow receiver inlet, and may be (at least partly) returned to the gas flow generator (for reuse).

Hence, in an embodiment the food preparation vessel comprises a vessel wall comprising a gas flow infrastructure for a fluid connection between the gas flow outlet, the gas flow generator, and the gas flow receiver inlet. For instance, at least part of the vessel wall may be double walled for allowing flow of gas. Note that the term “gas” in general refers herein to air. The term “gas flow infrastructure” may especially refer to one or more conduits for transport of gas (i.e. air). Such conduit(s) have of course not necessarily a circular cross-section. Any shape may in principle be possible, such as when e.g. integrated in part of the vessel wall.

As indicated above, the invention also provides a combination of a base station and the food preparation vessel. An advantage of using a base station is that amongst others the gas flow generator and/or a heating unit may be integrated in such base station. Further, the base station may include the control unit (see amongst others also above). Hence, in embodiments the vessel may include the above indicated gas flow generation outlet and the gas flow receiver inlet, and also a gas flow infrastructure, wherein the vessel may functionally be coupled to the base station (during at least part of a time for executing a method for preparing food). The base station may be configured provide heating to the vessel and the gas flow to the vessel. Hence, the vessel may be functionally coupled to the base station, and the base station, the gas flow infrastructure of the vessel, as well as the gas flow generation outlet and the gas flow receiver inlet, may be functionally coupled to the base station. For instance, the vessel and the base station may include a male-female connection for the gas flow infrastructure. In this way, a gas flow infrastructure of the vessel and a gas flow infrastructure of the base station may be in gaseous communication. The male-female connection of other gaseous communication connection may be configured to allow rotation of the food preparation vessel, especially in a horizontal plane.

Hence, in an embodiment the base station comprises a heating unit configured to heat at least part of the food preparation vessel. Hence, in yet another embodiment, which can be combined with the former embodiment(s), the base station comprises said flow generator and a control unit configured to control the gas flow of said flow generator.

Hence, the invention provides a food preparation vessel, a combination of a food preparation vessel and a base station, as well as a food preparation method, which can especially be used for preparing a food material, while reducing escape of one or more of food material and other material from the food preparation vessel with an air knife based gas flow while also allowing visible access from external from the food preparation vessel to the food material in the food preparation vessel. For instance, the other material may comprise one or more selected from the group consisting of gas, fat and steam.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1b schematically depict some aspects of the vessel and combination of vessel and base station;

FIGS. 2a-2f schematically depict some variants of the vessel and of the combination of the vessel and base station; and

FIGS. 3a-3e schematically depict some further aspects of the vessel and/or base station.

The drawings are not necessarily on scale.

### DETAILED DESCRIPTION OF THE EMBODIMENTS

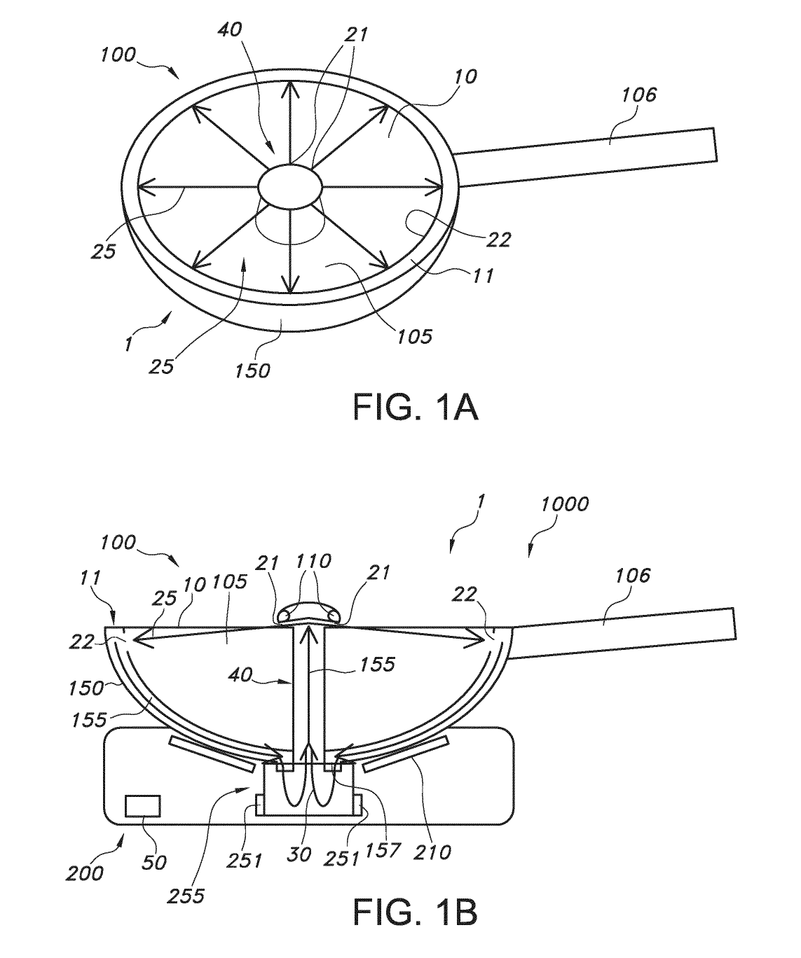

FIG. 1a schematically depicts an embodiment of a food preparation vessel 100 comprising a main inlet 10 for introduction of a food material—not depicted—into the food preparation vessel 100. The food preparation vessel 100 comprises a gas flow generator outlet 21 and a gas flow receiver inlet 22. The gas flow generator outlet 21 is configured to provide a gas flow especially an air knife based gas flow in the direction of the gas flow receiver inlet 22 and having a component parallel to the main inlet 10 when the gas flow generator outlet 21 is functionally coupled with a gas flow generator—not depicted—in operation. FIG. 1a is a perspective view. Reference 1 indicates a vessel selected from e.g. consisting of a frying pan, a steel pan, a braising pan, a roasting pan, a spider, a casserole pan, a Dutch oven, a griddle, a stockpot, a sauté pan, a sauce pan, and a wok. Note that the food preparation vessel 100 may essentially consist of such vessel, though especially the food preparation vessel 100 further comprises a gas flow infrastructure comprising one or more of the gas flow generator outlet 21 and a gas flow receiver inlet 22. Reference 105 indicates the vessel interior, i.e. the place where the food product is prepared from the food material. Reference 40 indicates a hub and reference 11 indicates the edge of the food preparation vessel or of the vessel interior 105. Hence, in this schematically depicted embodiment the main inlet 10 comprises a food preparation vessel inlet edge 11 comprising said gas flow receiver inlet 22. Further, this schematically depicted embodiment of the food preparation vessel 100 further comprises said hub 40, here comprising said gas flow generator outlet 21. As shown, the gas flow generator outlet 21 is configured in this embodiment to provide a radial gas flow 25 in the direction of said gas flow receiver inlet 22 and has a component parallel see further also below to the main inlet 10 when functionally coupled with said gas flow generator in operation. Reference 106 indicates a handle.

FIG. 1b schematically depicts in more detail an embodiment of a combination 1000 of a base station 200 and the food preparation vessel 100, such as schematically depicted above, wherein one or more of the base station 200 and the food preparation vessel 100 comprise said gas flow generator 30; here the base station comprises the gas flow generator 30. Hence, this figure schematically depicts a food preparation vessel system, wherein the food preparation vessel 100 can be functionally coupled to the base station 200 (or the other way around, the base station 200 can functionally be coupled to the food preparation vessel 100). This figure further schematically depicts the gas flow infrastructure 155 of the vessel 100. Here, the food preparation vessel 100 comprises a vessel wall 150 comprising said gas flow infrastructure 155 for a fluid connection between the gas flow outlet 21, the gas flow generator 30, and the gas flow receiver inlet 22.

Further, the combination comprises a control unit 50, here integrated in the base station 200, and a heater system 210, here also integrated in the base station 200. Further, the combination 1000 comprises a sensor 110, which may especially be configured to sense an object external from the food preparation vessel 100 approaching the main inlet 10 or being positioned within the main inlet 10. In the schematically depicted embodiment of FIG. 1b, the sensor 110 is integrated in the food preparation vessel 100, here in the hub 40. The control unit 50 may be configured to control the heater system 210 and flow generator 30, optionally one or both in dependence of a sensor signal of the sensor 110. The flow (generator) may be controlled in dependence of a sensor signal of the sensor 110 but may alternatively or additionally also manually be contorlled, e.g. via a switch or (other) user interface comprised by the food preparation vessel 100 and/or (optional) base station 200. The terms “switch”, “user interface”, “sensor”, may, as also indicated below in the general consideration, also refer to “switches”, “user interfaces”, “sensors”, respectively. References 157 indicates an optional filter and/or means to remove liquid (e.g. condensed water). This filter may e.g. be used to remove particles, such as ramianing fat from the gas flow, before it is introduced again in the gas flow infrastructure 155 to escape from the gas flow generation outlet 21.

The gas flow 25 is especially able to capture smell and/or splashes coming from the food material inside the vessel. Further, with the air knife gas flow 25 the food can be viewed via the main inlet through the gas flow during preparation, in contrast to e.g. a closed air fryer.

The base station 200 and the food preparation vessel may functionally be coupled e.g. via (a) male-female connection(s). In this way, the gas loop may provided from base station 200 to food preparstion vessel, and vice versa. Reference 255 indicates a gas flow infrastructure of the base station 200. This gas flow infrastructure 255 of the base station and the gas flow infrastructure 155 of the food preparation vessel may be in fluid communication during use of the combination 1000. As indicated above, the gas flow 25 may be heated to provide a heated gas flow 25. In the embodiment schematicallly depicted in FIG. 1b, the base station 200 comprises gas flow heating element 251 (here by way of example two elements are schematically depicted), which is configured to heat the gas in the gas flow infrastructure 155 or 255 (here gas flow infrastructure 255). Hence, the gas flow when emanatating from the gas flow generator outlet 21 may comprise a heated gas, such as heated to at least 50° C. The schematically depicted embodiment of FIG. 1b might allow rotation of the food preparation vessel in a horizontal plane.

As shown in FIGS. 1a and 1b, the gas flow 25 has a component parallel to the main inlet. For instance, assuming a cross-sectional plane through the main inlet 10 or main inlet edge 11, the gas flow 25 may have a component parallel to such plane. As can be seen from amongst others FIGS. 1a-1b the gas flow generator outlet(s) 21 and the gas flow receiver inlet(s) 22 are especially configured to keep a substantial part of the internal volume (vessel interior 105) of the food preparation vessel 100 available for the preparation of food, and thus especially substantially free from the direct gas flow.

The food preparation vessel 100 and base station 200 may be configured such that when the food preparation vessel 100 is rotated during use, the fluid communication between the food preparation vessel and base station remain.

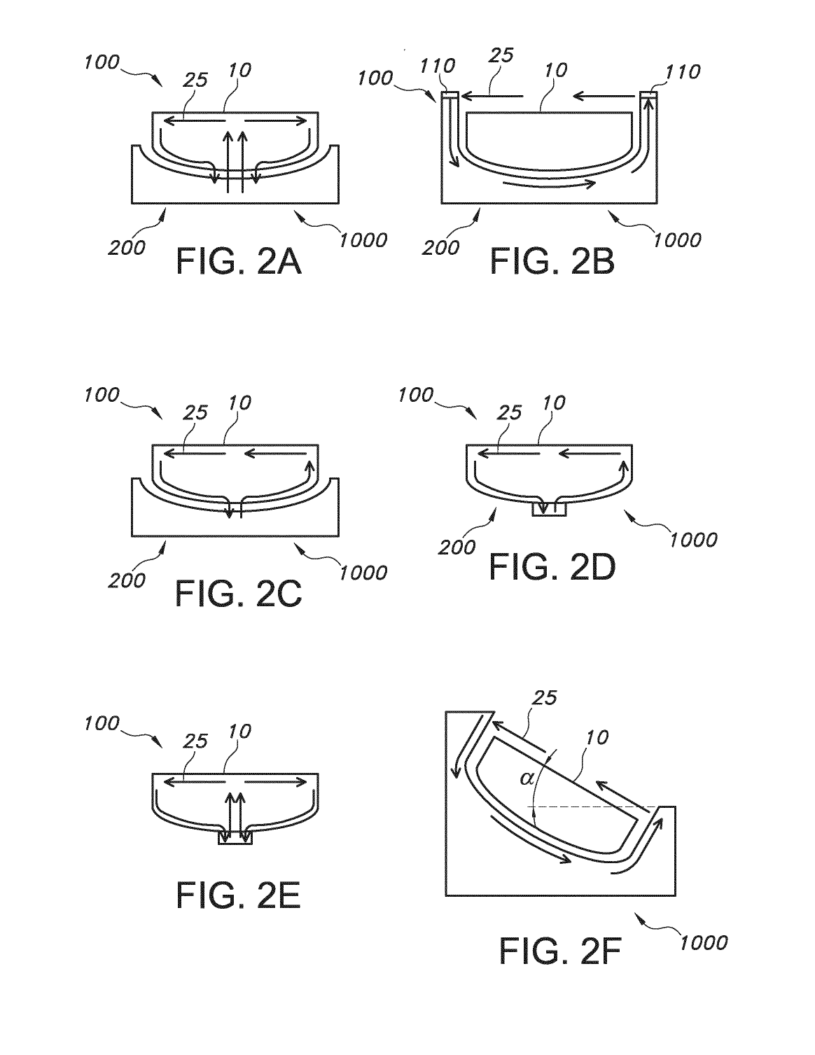

FIGS. 2a-2f schematically depict some variants of the food preparation vessel 100, optionally in combination with a base station 200. FIGS. 2a, 2b, 2c and 2f show variants of the combination 1000 of the food preparation vessel 100 and the base station 200, with in FIG. 2a a variant similar to FIG. 1b, but with FIG. 2b showing a variant wherein the entire gas infrastructure is integrated in the base station 200. The arrows schematically indicate the direction of the gas flow. The variants of FIG. 2a and FIG. 2c are substantially the same, though the variant of FIG. 2a scheamtically depicts a variant with a radial gas flow 25 whereas in FIG. 2c the gas flow 25 flows from edge to edge. For instance, the food preparation vessel 100 may in such embodiment be square or rectangular. FIGS. 2d and 2e schematically depict variants analogously to those of FIGS. 2a and 2c, but in the variants of FIGS. 2d and 2e the gas flow infrastructure is entirely integrated in the food preparation vessel 100. Hence, no base station may be necessary. FIG. 2f schematically depicts a variant similar to the variant of FIG. 2b, but here the main inlet 10 is configured not horizontal during operation. The angle α may e.g. be in the range of e.g. 15-80°.

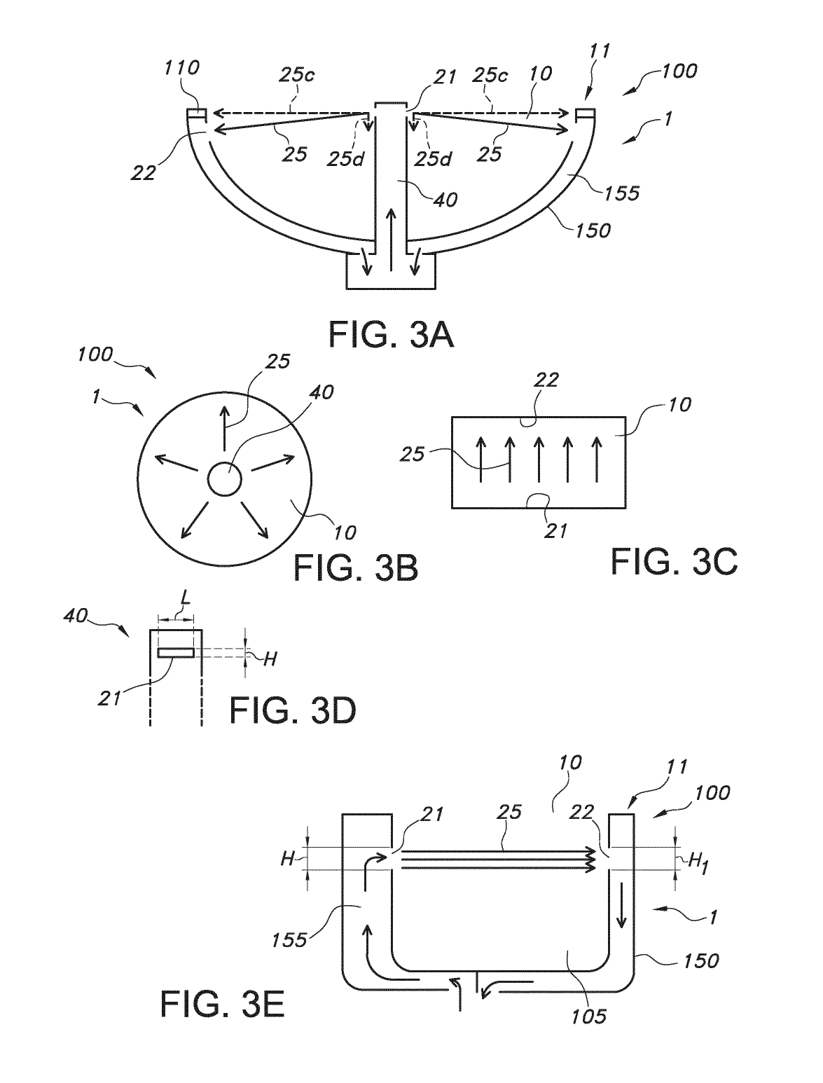

FIG. 3a shows some aspects of the gas flow 25 for a variant similar to those of FIGS. 2a-2b. However, the explanation in relation to FIG. 3a relates also to the other embodiments/variants. Here, the gas flow 25 is splitted in two components, a first component 25c parallel to the main inlet 10 and a second component 25d perpendicular to the first component 25c. Note that the length of the first component is substantially larger than of the second component, such as at least 5, even more at least 10 times, yet even more at least 20 times larger. Hence, the gas flow 25 is substantially sheet like.

FIGS. 3b and 3c schematically depict two main embodiments, one with a radial gas flow 25 and one with a substantially rectangular gas flow. Note however that both embodiments of the gas flow 25 are especially sheet like gas flows. Further, note that both gas flows may substantially close the entire main inlet 10. Referring to FIGS. 3b-c, when an object would be introduced into the food preparation vessel 100, the gas flow 25 over (in) the entire main inlet 10 may be reduced (including switched off), or only over (in) part of the main inlet 10. FIG. 3d schematically depicts in more detail an embodiment of the gas flow generator outlet 21, with a length L and a height H, with L>>H. Such configuration may facilitate a sheet like gas flow. FIG. 3e schematically depicts some aspects of the gas flow 25. As shown, the gas flow may be a substantially sheet like gas flow. The height H of the opening of the gas flow generator outlet 21 may substantially be the same as the height of the opening of the gas flow receiver inlet 22, which heigh is indicated with reference H1. In general, 0.5≦H1/H≦10, especially 0.8≦H1/H≦6, like 0.8≦H1/H≦5.

The term “substantially” herein, such as in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Furthermore, some of the features can form the basis for one or more divisional applications.

1. A food preparation vessel comprising a main inlet for introduction of a food material into the food preparation vessel, wherein the food preparation vessel comprises a gas flow generator outlet and a gas flow receiver inlet, wherein the gas flow generator outlet is configured to provide a gas flow in the direction of the gas flow receiver inlet and having a component parallel to the main inlet when the gas flow generator outlet is functionally coupled with a gas flow generator in operation.

2. The food preparation vessel according to claim 1, further comprising a hub, wherein the hub comprises said gas flow generator outlet, wherein the main inlet comprises a food preparation vessel inlet edge, wherein the vessel inlet edge comprises said gas flow receiver inlet, wherein the gas flow generator outlet is configured to provide a radial gas flow in the direction of said gas flow receiver inlet and having a component parallel to the main inlet when functionally coupled with said gas flow generator in operation.

3. The food preparation vessel according to claim 1, wherein the main inlet comprises a food preparation vessel inlet edge, wherein the food preparation vessel inlet edge comprises said gas flow generator outlet and said gas flow receiver inlet.

4. The food preparation vessel according to claim 1, comprising a vessel wall comprising a gas flow infrastructure for a fluid connection between the gas flow outlet, the gas flow generator, and the gas flow receiver inlet.

5. The food preparation vessel according to claim 1, wherein the gas flow generator is at least partially integrated in the food preparation vessel.

6. The food preparation vessel according to claim 1, further comprising a sensor configured to sense an object external from the food preparation vessel approaching the main inlet or being positioned within the main inlet, wherein a control unit when functionally coupled to said sensor and said gas flow generator is configured to reduce the gas flow as function of a sensor signal of said sensor.

7. The food preparation vessel according to claim 1, wherein the gas flow generator outlet has a length (L) and a height (H), wherein L>H, and wherein 0.1 mm≦H≦0.5 mm.

8. The food preparation vessel according to claim 1, wherein the gas flow generator outlet is configured to provide said gas flow with a gas flow speed of at least 10 m/s.

9. The food preparation vessel according to claim 1, wherein the food preparation vessel comprises a vessel selected from the group consisting of a frying pan, a steel pan, a braising pan, a roasting pan, a spider, a casserole pan, a Dutch oven, a griddle, a stockpot, a sauté pan, a sauce pan, and a wok.

10. A combination of a base station and the food preparation vessel according to claim 1, wherein one or more of the base station and the food preparation vessel comprise said gas flow generator.

11. The combination according to claim 10, wherein the base station comprises a heating unit configured to heat at least part of the food preparation vessel.

12. The combination according to claim 10, wherein the base station comprises said flow generator.

13. The combination according to claim 12, wherein the combination further comprises a control unit, wherein the food preparation vessel further comprises a sensor configured to sense an object external from the food preparation vessel approaching the main inlet or being positioned within the main inlet, wherein the control unit is configured to reduce the gas flow as function of a sensor signal of said sensor.

14. Use of the food preparation vessel according to claim 1, for preparing a food material, while reducing escape of one or more of food material and other material from the food preparation vessel with an air knife based gas flow while also allowing visible access from external from the food preparation vessel to the food material in the food preparation vessel, wherein the other material comprises one or more selected from the group consisting of gas, fat and steam.

15. A method for preparing food comprising heating food material into the food preparation vessel according to claim 1 during a food preparation time, while closing the main inlet with an air knife based gas flow during at least part of the preparation time.
